(19) United States
(12) Patent Application Publication
(10) Pub. No.: US 2022/0110071 A1
(43) Pub. Date: Apr. 7, 2022

(54) POWER HEADROOM REPORTING FOR SIMULTANEOUS TRANSMISSIONS OF NEW RADIO PUCCH AND PUSCH ON DIFFERENT COMPONENT CARRIERS

(71) Applicant: QUALCOMM Incorporated, San Diego, CA (US)

(72) Inventors: Seyedkianoush HOSSEINI, San Diego, CA (US); Yi HUANG, San Diego, CA (US); Wei YANG, San Diego, CA (US); Linhai HE, San Diego, CA (US); Peter GAAL, San Diego, CA (US); Wanshi CHEN, San Diego, CA (US)

(21) Appl. No.: 17/450,050

(22) Filed: Oct. 5, 2021

Related U.S. Application Data
(60) Provisional application No. 63/154,385, filed on Feb. 26, 2021.
(60) Provisional application No. 63/088,424, filed on Oct. 6, 2020.

(51) Int. Cl. H04W 52/36; H04W 52/14; H04W 72/12; H04W 72/04; H04W 80/02

(52) U.S. Cl. CPC H04W 52/365; H04W 52/146; H04W 80/02; H04W 72/0453; H04W 72/1268

(57) ABSTRACT

Wireless communications systems and methods related to the reporting of power headroom available for simultaneous or parallel physical uplink control channel (PUCCH) and physical uplink shared channel (PUSCH) transmissions on different component carriers are provided. In some aspects, a UE may generate a power headroom report including a power headroom for a simultaneous transmission, to a network device, of a PUCCH transmission on a first new radio component carrier and a PUSCH transmission on a second new radio component carrier different from the first new radio component carrier. The UE may then transmit to the network device the power headroom report including the power headroom.

### CROSS REFERENCE TO RELATED APPLICATIONS

The present application claims priority to and the benefit of U.S. Provisional Patent Application No. 63/088,424, filed Oct. 6, 2020, and U.S. Provisional Patent Application No. 63/154,385, filed Feb. 26, 2021, both titled “Power Headroom Reporting for Simultaneous Transmissions of New Radio PUCCH And PUSCH On Different Component Carriers,” which are hereby incorporated by reference in their entireties as if fully set forth below and for all applicable purposes.

### TECHNICAL FIELD

The technology described below relates generally to wireless communication systems, and more particularly to power headroom reports of simultaneous or parallel physical uplink control channel and physical uplink shared channel transmissions on different component carriers.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of network devices such as base stations (BSs) and user equipment (UE), each network device simultaneously supporting communications for multiple communication devices (e.g., user equipment (UE)).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum.

To assist a network device such as a BS to properly allocate uplink resources to multiple UEs, a UE may provide information to the network device about the power headroom that is available to the UE. Upon receiving the power headroom report (PHR), the BS may then determine how much uplink bandwidth per subframe the UE can use to communicate with the BS, avoiding allocating uplink transmission resources to UEs that may not be to utilize allocated resources fully or efficiently.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Some aspects of the present disclosure disclose a method of wireless communication performed by a user equipment (UE). The method may comprise generating a power headroom report (PHR) including a power headroom for a simultaneous transmission, to a network device, of a PUCCH transmission on a first new radio (NR) component carrier (CC) and a PUSCH transmission on a second NR CC different from the first NR CC; and transmitting the PHR to the network device.

Some aspects of the present disclosure disclose a user equipment (UE) comprising a memory; a processor coupled to the memory; and a transceiver coupled to the processor. In some aspects, the processor may be configured to generate a power headroom report (PHR) including a power headroom for a simultaneous transmission, to a network device, of a PUCCH transmission on a first new radio (NR) component carrier (CC) and a PUSCH transmission on a second NR CC different from the first NR CC. Further, in some aspects, the transceiver is configured to transmit the PHR to the network device.

Some aspects of the present disclosure disclose a non-transitory computer-readable medium (CRM) having program code recorded thereon. In some aspects, the program code may comprise code for causing a UE to generate a power headroom report (PHR) including a power headroom for a simultaneous transmission, to a network device, of a PUCCH transmission on a first new radio (NR) component carrier (CC) and a PUSCH transmission on a second NR CC different from the first NR CC. Further, the program code may comprise code for causing the UE to transmit the PHR to the network device.

Some aspects of the present disclosure disclose a user equipment (UE), comprising means for generating a power headroom report (PHR) including a power headroom for a simultaneous transmission, to a network device, of a PUCCH transmission on a first new radio (NR) component carrier (CC) and a PUSCH transmission on a second NR CC different from the first NR CC. Further, the UE may comprise means for transmitting the PHR to the network device.

Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIGS. 2A and 2B illustrate respectively long term evolution (LTE) extended and new radio multiple entry power headroom report (PHR) medium access control (MAC)-control elements (CEs) according to some aspects of the present disclosure.

FIG. 3 illustrates a signaling diagram of a method for power headroom reporting for simultaneous transmissions of PUSCH and PUCCH on different component carriers according to some aspects of the present disclosure.

FIG. 4 is a block diagram of an exemplary UE according to some aspects of the present disclosure.

FIG. 5 is a block diagram of an exemplary base station (BS) according to some aspects of the present disclosure.

FIG. 6 is a flow diagram of a wireless communication method according to some aspects of the present disclosure.

FIG. 7 is a flow diagram of a wireless communication method according to some aspects of the present disclosure.

FIG. 8 is a flow diagram of a wireless communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a Ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink (UL)/downlink (DL) scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and DL to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

To assist a network device (e.g., BS) to properly allocate uplink resources to multiple UEs, a UE may provide a power headroom report (PHR) to the network device about the power headroom that is available to the UE, which the network device can then use to allocate the uplink resources among the multiple UEs so that the resources are utilized by the multiple UEs efficiently. That is, the network device may determine based on the PHR how much uplink bandwidth per subframe a UE can use, which allows the BS to avoid allocating resources that the UE may not use.

In LTE, three types of PHRs are defined: type 1 PHR which reflects the power headroom assuming PUSCH-only transmission on the component carrier, type 2 PHR which reflects the power headroom assuming combined PUSCH and PUCCH transmission on the component carrier, and type 3 PHR which reflects the power headroom assuming sounding reference signal (SRS)-only transmission on the component carrier. In some aspects, the term “component carrier” may refer to a combination of several resource blocks, and may be used interchangeably with the term “cell”. As of 5G NR Release 16, 3GPP has not specified NR PHR for combined or simultaneous transmissions of PUSCH and PUCCH on NR component carriers (e.g., because simultaneous transmissions of PUSCH and PUCCH on NR component carriers is not allowed, whether inter-band or intra-band component carrier). Some aspects of the present disclosure disclose a type 2 kind (referred hereinafter as “type 2′”) PHR for simultaneous or parallel transmissions of PUCCH and PUSCH on different component carriers, which can be beneficial in facilitating forward compatibility if/when joint or simultaneous PUCCH and PUSCH transmissions on component carriers (e.g., inter-band or intra-band component carriers and/or a primary cell (PCell)) are specified in future 3GPP specification releases.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

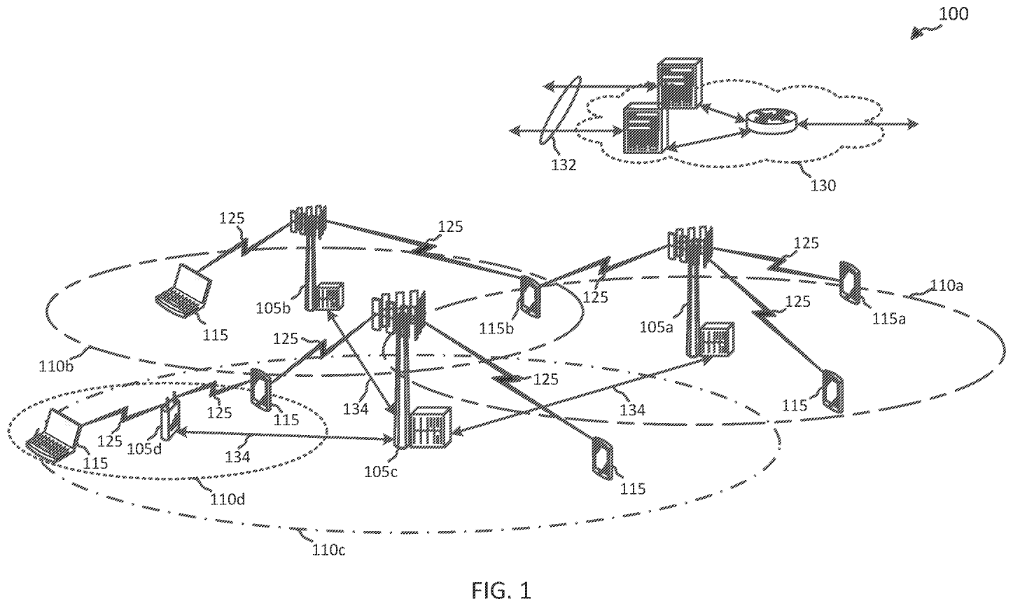

FIG. 1 illustrates a wireless communication network 100 according to some aspects of the present disclosure. The network 100 may be a 5G network. The network 100 includes a number of network devices such as user equipment (UE), base stations (BSs) 105 (individually labeled as 105a, 105b, 105c, 105d, 105e, and 105f) and other network entities. ABS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. Although the discussion in the present disclosure may refer to base stations being used to facilitate or effectuate communication between a UE and the network 100, in some aspects, other network devices such as UEs may also be used to accomplish same or at least substantially similar functions.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. ABS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 may be dispersed throughout the wireless network 100, and each UE 115 may be stationary or mobile. UEs can take in a variety of forms and a range of form factors. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115. As noted above, other network devices such as UEs can be used in place of, or in addition to, BS 105 to accomplish same or substantially similar functions.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. The random access procedure (or RACH procedure) may be a single or multiple step process. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. Scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the BS 105 may serve multiple UEs 115 each having one or more transmit antenna elements and/or one or more receive antenna elements. The BS 105 may multiplex multiple UEs 115 for simultaneous communications over different spatial layers. To assist the BS 105 in determining UL channel characteristics, the BS 105 may configure each UE 115 to sound one or more transmit antenna ports of the respective UE 115. Sounding may refer to the transmission of an SRS via one or more antenna ports. The SRS may include a waveform sequence (e.g., predetermined) that are known to the BS 105 and the UE 115. For instance, the SRS may be Zadoff-Chu sequence or any suitable waveform sequence. In some instances, a transmit antenna port at a UE 115 may map to a physical transmit antenna element of the UE 115. In some other instances, a transmit antenna port at a UE 115 may be a virtual antenna port or a logical port created by the UE 115, for example, via precoding. Precoding may include applying different amplitude weights and/or different phased adjustments to signals output by the physical transmit antenna elements of the UE 115 to produce a signal directed towards a certain spatial direction. In some aspects, the network 100 may operate in a TDD mode. The BS 105 may also estimate DL channel characteristics from UL SRSs received from the UEs 115 based on TDD channel reciprocity.

As mentioned above, a UE provides a BS a PHR about the power available to the UE to assist the UE in properly allocating UL resources to multiple UEs. in LTE, three types of PHRs are defined: type 1 PHR which reflects the power headroom assuming PUSCH-only transmission on the component carrier, type 2 PHR which reflects the power headroom assuming combined PUSCH and PUCCH transmissions on the component carrier, and type 3 PHR which reflects the power headroom assuming SRS-only transmission on the component carrier. A PHR can be triggered based on various criteria, which may include change in estimated path loss since the last power headroom report (e.g., when the difference between the current power headroom and the last report is larger than a configurable threshold), periodic reporting as controlled by a timer, and implementation of more than a configured number of closed-loop transmission power control (TPC) commands by the UE, etc. The BS can configure parameters to control each of these triggers depending on system load and the requirements of its scheduling algorithm. For example, the BS can use RRC to control the reporting of PHR by configuring the two timers periodicPTIR-Timer and prohibitPHR-Timer, and further by signaling dl-PathlossChange which may set the change in measured DL pathloss to trigger the PHR.

A UE may transmit a type 1 PHR for a component carrier or cell for when a PUSCH is scheduled or configured on the component carrier along with a PUCCH or for when a PUSCH is scheduled or configured on the component carrier but a PUCCH is not. In the latter case, i.e., when a PUSCH is scheduled or configured for transmission on a component carrier or serving cell c without a PUCCH, power headroom for a Type 1 PHR can be computed (in [dB]) using the actual or exact power parameters of the scheduled or configured PUSCH,

PH_{type1,c}(i)=P_{CMAX,c}(i)−{10 log₁₀(M_{PUSCH,c}(i))+P_{O_PUSCH,c}(j)+α_{c}(j)·PL_{c}+Δ_{TF,c}(i)+f_{c}(i)}, (Eq. 1)

where the parameters P_{CMAX,c}, M_{PUSCH,c}(i), P_{O_PUSCH,c}(j), α_{c}(j), PL_{c}, Δ_{TF,c}(i) and f_{c}(i) are defined as follows. P_{CMAX,c} is the configured UE transmit power in slot i for serving cell c, M_{PUSCH,c}(i) is the bandwidth of the PUSCH resource assignment expressed in number of resource blocks valid for slot i and serving cell c, α_{c}(j). is a 3-bit cell-specific value representing a weight applied to the pathloss for calculating uplink transmit power, P_{O_PUSCH,c}(j) denotes a parameter of higher layer as sum of cell-specific and UE-specific values, where j=1 is used for PUSCH (re)transmissions corresponding to a dynamic scheduled grant, PL_{c} is the downlink path loss estimate calculated in the UE for serving cell c (in dB), Δ_{TF,c}(i) is the power offset derived from the modulation and coding scheme (MCS) and f_{c}(i) is the accumulated value of the transmit power control on the serving cell c and denotes a parameter of higher layer as sum of cell-specific and UE-specific values.

When a PUSCH and a PUCCH are both scheduled or configured for transmission on a component carrier or serving cell c, the power headroom for a Type 1 PHR can be computed (in [dB]) using the actual or exact power parameters of the scheduled or configured PUSCH,

PH_{type1,c}(i)=\tilde{P}_{CMAX,c}(i)−{10 log₁₀(M_{PUSCH,c}(i))+P_{O_PUSCH,c}(j)+α_{c}(j)·PL_{c}+Δ_{TF,c}(i)+fc(i)}, (Eq. 2)

where P_{CMAX,c}(i) is a configured maximum transmit power value computed assuming a PUSCH only transmission in slot i for serving cell c. When a PUSCH is not scheduled or configured for transmission on a component carrier or serving cell c, i.e., when the UE does not transmit PUSCH in slot i for serving cell c, the power headroom for a Type 1 PHR can be computed (in [dB]) using the PUSCH transmission reference parameters via the expression

PH_{type1,c}(i)=\tilde{P}_{CMAX,c}(i)−{P_{O_PUSCH,c}(j)+α_{c}(j)·PL_{c}+f_{c}(i)}, (Eq. 3)

where \tilde{P}_{CMAX,c}(i) is a configured maximum transmit power value computed assuming the maximum power reduction MPR=0 dB, the additional MPR A-MPR=0 dB, the power management maximum power reduction P-MPR=0 dB, and ΔT_{C}=0 dB. MPR, A-MPR and ΔT_{C} are the parameters for defining the ceiling value to adjust maximum UE transmission power on the serving cell such that the unintended radiation or interference to adjacent channel meet to a predetermined requirement. MPR is the value determined according to the amount of transmission resource allocated to the UE and modulation scheme. A-MPR is the value determined according to uplink frequency band, geographical characteristic, and uplink transmission bandwidth. A-MPR can be used for the case of frequency band particularly sensitive to ambient spurious radiation. ΔT_{C} is the parameter for allowing additional transmission power adjustment in case where uplink transmission is performed at an edge of the frequency band.

As noted above, type 2 PHR may reflect the power headroom assuming combined PUSCH and PUCCH transmissions on the component carrier. Depending on whether one or both of PUSCH or PUCCH transmissions are configured or scheduled for transmission in slot i for the primary cell, the power headroom may be computed and a type 2 PHR may be sent by the UE to the BS. When both PUSCH and PUCCH are configured or scheduled on a component carrier c, i.e., if the UE transmits PUSCH simultaneous with PUCCH in slot i for the primary cell c, power headroom for a Type 2 PHR can be computed (in dB) taking both configured PUSCH and PUCCH into consideration using

$$P {H}_{type 2} ( i ) = {P}_{CMAX , c} ( i ) - 10 {log}_{10} ( \begin{matrix}{10}^{( 10 {log}_{10} ( {M}_{PUSCH , c} ( i ) ) + {P}_{O\_PUSCH , c} ( j ) + {α}_{c} ( j ) \cdot {PL}_{c} + {Δ}_{TF , c} ( i ) + {f}_{c} ( i ) ) / 10} + \\ {10}^{( {P}_{0 \_ PUCCH} + P {L}_{c} + h ( {n}_{CQI} , {n}_{HARQ} , {n}_{SR} ) + {Δ}_{F\_PUCCH} ( F ) + {Δ}_{T x D} ( {F}^{′} ) + g ( i ) ) / 10}\end{matrix} ) , \qquad ( Eq . 4 )$$

where the PUCCH and PUSCH components of the power headroom include the exact or actual power parameters of the PUCCH and PUSCH transmissions, respectively. P_{O_PUCCH}, h(n_{CQI},n_{HARQ},n_{SR}), Δ_{F_PUCCH}(F), Δ_{TxD}(F′) and g(i) are defined as follows. P_{O_PUCCH} denotes a parameter of higher layer as sum of cell-specific and UE-specific values and h(n_{CQI},n_{HARQ},n_{SR}) is a PUCCH format dependent value, where n_{CQI} corresponds to the number of information bits for the channel quality information, n_{HARQ} is the number of HARQ-ACK bits sent in slot i, and n_{SR}=1 if slot i is configured for scheduling request (SR) for the UE not having any associated transport block for UL-SCH, otherwise n_{SR}=0. Further, Δ_{F_PUCCH}(F) is provided by higher layers, as is Δ_{TxD}(F′) (otherwise it is 0), and g(i) is the current PUCCH power control adjustment state.

When PUSCH is configured or scheduled but PUCCH is not configured or scheduled, for transmission on the component carrier c, i.e., if the UE transmits PUSCH without PUCCH in slot i of the primary cell, power headroom for a Type 2 PHR can be computed (in dB) using

$$P {H}_{type 2} ( i ) = {P}_{CMAX , c} ( i ) - 10 {log}_{10} ( \begin{matrix}{10}^{( 10 {log}_{10} ( {M}_{PUSCH , c} ( i ) ) + {P}_{O\_PUSCH , c} ( j ) + {α}_{c} ( j ) \cdot {PL}_{c} + {Δ}_{TF , c} ( i ) + {f}_{c} ( i ) ) / 10} + \\ {10}^{( {P}_{0 \_ PUCCH} + P {L}_{c} + g ( i ) ) / 10}\end{matrix} ) , \qquad ( Eq . 5 )$$

where the PUSCH and PUCCH components of the power headroom include the exact or actual power parameters of the PUSCH transmission and the reference parameters of the PUCCH transmission, respectively.

When PUCCH is configured or scheduled but PUCSH is not configured or scheduled, for transmission on the component carrier c, i.e., if the UE transmits PUCCH without PUSCH in slot i of the primary cell, power headroom for a Type 2 PHR can be computed (in dB) using

$$P {H}_{type 2} ( i ) = {P}_{CMAX , c} ( i ) - 10 {log}_{10} ( \begin{matrix}{10}^{( {P}_{O\_PUSCH , c} ( 1 ) + {α}_{c} ( 1 ) \cdot {PL}_{c} + {f}_{c} ( i ) ) / 10} + \\ {10}^{( {P}_{0 \_ PUCCH} + P {L}_{c} + h ( {n}_{CQI} , {n}_{HARQ} , {n}_{SR} ) + {Δ}_{F\_PUCCH} ( F ) + {Δ}_{T x D} ( {F}^{′} ) + g ( i ) ) / 10}\end{matrix} ) , \qquad ( Eq . 6 )$$

where the PUCCH and PUSCH components of the power headroom include the exact or actual power parameters of the PUCCH transmission and the reference parameters of the PUSCH transmission, respectively.

When neither PUCCH nor PUSCH is configured or scheduled for transmission on the component carrier c, i.e., if the UE does not transmit PUCCH or PUSCH in slot i for the primary cell, power headroom for a Type 2 PHR can be computed (in dB) using

$$P {H}_{type 2} ( i ) = {\tilde{P}}_{CMAX , c} ( i ) - 10 {log}_{10} ( \begin{matrix}10 ( {P}_{O\_PUSCH , c} ( 1 ) + {α}_{c} ( 1 ) \cdot {PL}_{c} + {f}_{c} ( i ) ) / 10 + \\ 10 ( {P}_{0 \_PUCCH} + P {L}_{c} + g ( i ) ) / 10\end{matrix} ) , \qquad ( Eq . 7 )$$

where the PUCCH and PUSCH components of the power headroom include the reference parameters of the PUCCH and PUSCH transmission, respectively.

The maximum output power control for component carrier or serving cell c, P_{CMAX,c}, can be configured by the UE itself and is bound within the set P_{CMAX_L,c}≤P_{CMAX,c}≤P_{CMAX_H,c}, where the lower bound P_{CMAX_L,c} is expressed as:

P_{CMAX_L,c}=min{P_{EMAX,c}−ΔT_{C,c},(P_{PowerClass}−ΔP_{PowerClass})−max(MPR_{c}+A−MPR_{c}+ΔT_{IB,c}+ΔT_{C,c}+JΔT_{ProSe},P-MPR_{c})},

and the upper bound P_{CMAX_H,c} is expressed as P_{CMAX_H,c}=min{P_{EMAX,c},P_{PowerClass}−ΔP_{PowerClass}}. P_{EMAX,c} is the value given to IE P-Max, which is used to limit the UE's uplink transmission power on a carrier frequency. P_{PowerClass} is the maximum UE power specified without taking into account tolerance. ΔT_{C} is equal to either about 1.5 dB or about zero dB. Because there is no dependency on how P_{CMAX,c} is set across different carriers, i.e., because P_{CMAX,c} for a component carrier c has no dependency on other carriers, a BS may be capable of determining power headroom available for less number of carriers than is reported by a UE in a PHR. For example, a UE may send a type 1 PHR for three carriers to the BS, and based on this PHR, the BS may be capable of determining the power headroom available for two carriers (e.g., in case the next scheduling time has only two PUSCHs scheduled).

The total configured maximum output power P_{CMAX} is set within the bound P_{CMAX_L}≤P_{CMAX}≤P_{CMAX_H}. For uplink inter-band carrier aggregation with one serving cell c per operating band when same transmission time interval pattern is used in all aggregated serving cells, the lower bound P_{CMAX_L} is expressed as: P_{CMAX_L}=min{10 log₁₀Σmin [p_{EMAX,c}/Δt_{C,c}), p_{PowerClass}/(mpr_{c}·a-mpr_{c}·Δt_{C,c}·Δt_{IB,c}·Δt_{IB,c}·Δt_{ProSe}), p_{PowerClass}/pmpr_{c}], P_{PowerClass}}, and the upper bound is P_{CMAX_H} is expressed as P_{CMAX_H}=min{10 log₁₀Σp_{EMAX,c},P_{PowerClass}}. P_{EMAX,c} is the linear value of P_{EMAX,c}, mpr_{c} and a-mpr_{c} are the linear values of MPR_{c} and A-MPR_{c}, pmpr_{c} is the linear value of P-MPR_{c}, Δt_{C,c} is the linear value of ΔT_{C,c}.

For uplink intra-band contiguous and non-contiguous carrier aggregation when same transmission time interval pattern is used in all aggregated serving cells, the lower bound P_{CMAX_L} is expressed as: P_{CMAX_L}=min {10 log₁₀ΣP_{EMAX,c}−ΔT_{C}, (P_{PowerClass}−ΔP_{PowerClass})−max(MPR+A-MPR+ΔT_{IB,c}+ΔT_{C}±ΔT_{ProSe}, P-MPR)}. That is, for intra-band either contiguous and non-contiguous carrier aggregation, MPR_{c}=MPR and A-MPR_{c}=A-MPR, which means the sum total MPR+A-MPR is the same for all component carriers. Although there is dependency on how P_{CMAX,c} is set across different carriers, i.e., although P_{CMAX,c} for a component carrier c has dependency on other carriers (due to MPR_{c}=MPR and A-MPR_{c}=A-MPR, for example), a BS may still be capable of determining power headroom available for less number of carriers than is reported by a UE in a PHR. For example, a UE may send a type 1 PHR for three carriers to the BS, and based on within the margin of uncertainty in setting MPR, A-MPR, etc., the BS may be capable of determining the power headroom available for two carriers (e.g., in case the next scheduling time has only two PUSCHs scheduled).

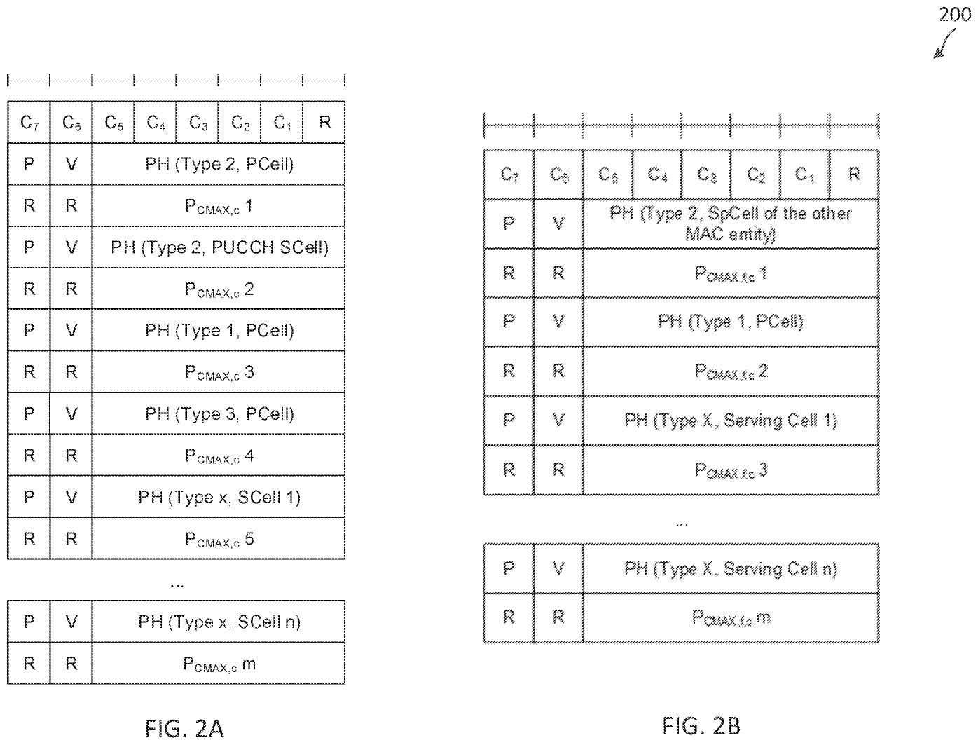

FIGS. 2A and 2B illustrate respectively long term evolution (LTE) extended and new radio (NR) multiple entry power headroom report (PHR) medium access control (MAC)-control elements (CEs) according to some aspects of the present disclosure. A UE may send to a BS the afore-mentioned LTE type 1, type 2 and type 3 PHR, for example, using an LTE extended PHR MAC-CE, an example structure of which is shown in FIG. 2A. NR PHR, such as those disclosed in the present disclosure, can also be sent by the UE to the BS via a NR multiple entry PHR MAC-CE, an example structure of which is also shown in FIG. 2B.

The LTE extended PHR MAC control elements such as those shown in FIG. 2A can be identified by a MAC protocol data unit (PDU) subheader with identity of the logical channel (LCD). They have variable sizes and one octet with C fields may be used for indicating the presence of PH per secondary cell (SCell) when the highest SCellIndex of SCell with configured uplink is less than 8, otherwise four octets can be used. When Type 2 PH is reported for the PCell, the octet containing the Type 2 PH field is included first after the octet(s) indicating the presence of PH per SCell and followed by an octet containing the associated P_{CMAX,c} field (if reported). Then follows the Type 2 PH field for the PUCCH SCell (if PUCCH on SCell is configured and Type 2 PH is reported for the PUCCH SCell), followed by an octet containing the associated P_{CMAX,c} field (if reported). Then follows an octet with the Type 1 PH field and an octet with the associated P_{CMAX,c} field (if reported), for the PCell. Then follows in ascending order based on the ServCellIndex, an octet with the Type x PH field, wherein, x is equal to 3 when the ul-Configuration-r14 is configured for this SCell, x is equal to 1 otherwise, and an octet with the associated P_{CMAX,c} field (if reported), for each SCell indicated in the bitmap.

The LTE extended PHR MAC CEs are defined as follows: Cᵢ is a field that indicates the presence of a PH field for the SCell with SCellIndex i. The C, field set to “1” indicates that a PH field for the SCell with SCellIndex i is reported. The C, field set to “0” indicates that a PH field for the SCell with SCellIndex i is not reported. R is a reserved bit, set to “0”. V is a field that indicates if the PH value is based on a real transmission or a reference format. For Type 1 PH, V=0 indicates real transmission on PUSCH and V=1 indicates that a PUSCH reference format is used. For Type 2 PH, V=0 indicates real transmission on PUCCH and V=1 indicates that a PUCCH reference format is used. For Type 3 PH, V=0 indicates real transmission on SRS and V=1 indicates that an SRS reference format is used. Furthermore, for Type 1, Type 2 and Type 3 PH, V=0 indicates the presence of the octet containing the associated P_{CMAX,c} field, and V=1 indicates that the octet containing the associated P_{CMAX,c} field is omitted. The field PH indicates the power headroom level. The length of the field is 6 bits. The field P indicates whether the MAC entity applies power backoff due to power management (as allowed by P-MPR_{c}). The MAC entity can set P=1 if the corresponding P_{CMAX,c} field would have had a different value if no power backoff due to power management had been applied. The field P_{CMAX,c}, if present, may indicate the P_{CMAX,c} or \tilde{P}_{CMAX,c} can be used for calculation of the preceding PH field.

The NR multiple entry PHR MAC CE such as those shown in FIG. 2B can be identified by a MAC PDU subheader with LCD. It has a variable size, and includes the bitmap, a Type 2 PH field and an octet containing the associated P_{CMAX,f,c} field (if reported) for the special cell (SpCell) of this MAC entity, a Type 2 PH field and an octet containing the associated P_{CMAX,f,c} field (if reported) for either SpCell of the other MAC entity or PUCCH secondary cell (SCell), a Type 1 PH field and an octet containing the associated P_{CMAX,f,c} field (if reported) for the PCell. It further includes, in ascending order based on the ServCellIndex, one or multiple of Type X PH fields and octets containing the associated P_{CMAX,f,c} fields (if reported) for Serving Cells other than PCell indicated in the bitmap. X is either 1 or 3.

The presence of Type 2 PH field for SpCell of this MAC entity is configured by phr-Type2SpCell, and the presence of Type 2 PH field for either SpCell of the other MAC entity or for PUCCH SCell of this MAC entity is configured by phr-Type2OtherCell. It is to be noted that the type 2 PH field in the NR multiple entry PHR MAC CE (e.g., as shown in FIG. 2B) indicates power headroom level for the SpCell of the other MAC entity (i.e. E-UTRA MAC entity in EN-DC case only). That is, as noted above, 3GPP does not specify or allow a type 2 PHR for parallel or simultaneous transmissions of PUSCH and PUCCH on a NR component carrier.

A single octet bitmap is used for indicating the presence of PH per Serving Cell when the highest ServCellIndex of Serving Cell with configured uplink is less than 8, otherwise four octets are used. UE determines whether PH value for an activated Serving Cell is based on real transmission or a reference format by considering the downlink control information which has been received until and including the PDCCH occasion in which the first UL grant for a new transmission is received since a PHR has been triggered. The NR PHR MAC CEs fields are defined in similar manner as discussed above with respect to the LTE extended PHR MAC CEs.

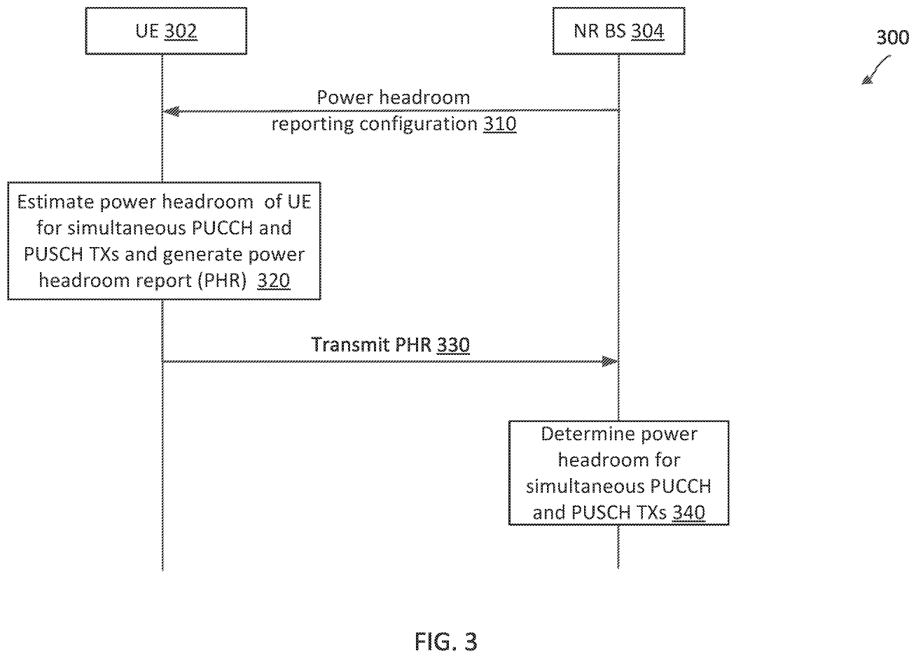

As noted above, as of 5G NR Release 16, 3GPP has not specified NR PHR for combined or simultaneous transmissions of PUSCH and PUCCH on a NR component carrier, because parallel PUSCH and PUCCH transmissions are not allowed on component carriers (whether inter-band or intra-band component carriers). Some aspects of the present disclosure disclose a type 2 kind (referred hereinafter as “type 2”) PHR for simultaneous or parallel transmissions of PUCCH and PUSCH on different component carriers. FIG. 3 illustrates an example signaling diagram of a method for such power headroom reporting for simultaneous transmissions of PUSCH and PUCCH on different component carriers, according to some aspects of the present disclosure. The method 300 may be employed by a NR BS 304, such as BS 105, and a UE 302, such as UE 115, to report power headroom available at the UE for simultaneous transmissions of PUSCH and PUCCH on different component carriers, as described in greater detail below. As illustrated, the method 300 includes a number of enumerated actions, but embodiments of the method 300 may include additional actions before, after, and in between the enumerated actions. In some embodiments, one or more of the enumerated actions may be omitted or performed in a different order.

At action 310, the NR BS 304 may transmit a RRC message (e.g., RRC setup, RRC configuration, etc.) to configure the reporting of power headroom, i.e., the sending of a PHR, to the NR BS 304 by the UE 302. For example, the RRC message may include parameters such as phr-PeriodicTimer, phr-ProhibitTimer, phr-Tx-PowerFactorChange, phr-Type2SpCell, phr-Type2OtherCell, phr-ModeOtherCG, and multiplePHR to configure the reporting of the power headroom. In some aspects, the PHR may be configured to be reported periodically (e.g., because of expiration of a periodic timer) or when triggered based on a threshold. For example, the reporting of the power headroom via the PHR may be periodically triggered by the expiration of a periodic timer, for instance, phr-PeriodicTimer, which can be configured with values ranging from about 10 ms to infinity. The power headroom reporting may also be triggered based on a threshold such as path loss changes. For instance, a NR PHR may be triggered when phr-ProhibitTimer expires or has expired and the path loss has changed more than phr-Tx-PowerFactorChange dB for at least one activated serving cell of any MAC entity which is used as a pathloss reference since the last transmission of a PHR in this MAC entity when the MAC entity has UL resources for new transmission. In some cases, the path loss variation for one cell assessed above can be between the pathloss measured at present time on the current pathloss reference and the pathloss measured at the transmission time of the last transmission of PHR on the pathloss reference in use at that time, irrespective of whether the pathloss reference has changed in between.

In some aspects, the NR PHR may also be triggered upon configuration or reconfiguration of the power headroom reporting functionality by upper layers, which is not used to disable the function. Further, the NR PHR may be triggered upon activation of an SCell of any MAC entity with configured uplink or addition of the PSCell (i.e. PSCell is newly added or changed). Further, the PHR may be triggered when phr-ProhibitTimer expires or has expired, when the MAC entity has UL resources for new transmission, and for any of the activated serving cells of any MAC entity with configured uplink, there are UL resources allocated for transmission or there is a PUCCH transmission on this cell, and the required power backoff due to power management (as allowed by P-MPR_{c}) for this cell has changed more than phr-Tx-PowerFactorChange dB since the last transmission of a PHR when the MAC entity had UL resources allocated for transmission or PUCCH transmission on this cell. In some cases, the MAC entity can avoid triggering a PHR when the required power backoff due to power management decreases only temporarily (e.g. for up to a few tens of milliseconds) and it can avoid reflecting such temporary decrease in the values of P_{CMAX,f,c}/PH when a PHR is triggered by other triggering conditions.

At action 320, after the triggering of a NR PHR when a PHR triggering condition disclosed above is fulfilled, the UE 302 may estimate or measure the power headroom available for simultaneous or parallel transmissions of PUSCH and PUCCH on different component carriers to generate a NR PHR to send to the BS 304. In some aspects, the different component carriers can be inter-band component carriers or intra-band component carriers. In some aspects, the NR PHR may be similar to the type 2 LTE PHR, with the main difference that the simultaneous or parallel transmissions of PUSCH and PUCCH occur on different component carrier, unlike the case of LTE where they may occur on same component carrier. The introduction of a new kind of type 2 PHR (referred hereinafter as “type 2”) in the present disclosure for simultaneous or parallel transmissions of PUCCH and PUSCH on different component carriers can facilitate forward compatibility for when joint or simultaneous PUCCH and PUSCH transmissions on same component carriers (e.g., inter-band or intra-band component carriers and/or a primary cell (PCell)) are specified in future 3GPP specification releases.

In some aspects, type 2′ PHR may include power headroom for when only PUCCH transmission is scheduled or configured on one component carrier (e.g., PCell/PSCell). That is, no PUSCH transmission may be scheduled or configured on the same component carrier on which the PUCCH transmission is scheduled or configured. In such cases, the type 2′ PHR may include a power headroom including an actual power of the PUCCH transmission and a reference power of a PUSCH transmission. In some aspects, the power headroom may be determined or calculated using the expression (Equation 6) for the equivalent LTE type 2 power headroom for when PUCCH is configured or scheduled but PUCSH is not configured or scheduled, for transmission on the component carrier c, i.e., for when the UE transmits PUCCH without PUSCH in slot i of the primary cell,

$$P {H}_{type 2} ( i ) = {P}_{CMAX , c} ( i ) - 10 {log}_{10} ( \begin{matrix}{10}^{( {P}_{O\_PUSCH , c} ( 1 ) + {α}_{c} ( 1 ) \cdot {PL}_{c} + {f}_{c} ( i ) ) / 10} + \\ {10}^{( {P}_{0 \_ PUCCH} + P {L}_{c} + h ( {n}_{CQI} , {n}_{HARQ} , {n}_{SR} ) + {Δ}_{F\_PUCCH} ( F ) + {Δ}_{T x D} ( {F}^{′} ) + g ( i ) ) / 10}\end{matrix} ) .$$

In some cases, a PUSCH transmission may be scheduled or configured on another component carrier (e.g., SCell), in which case the UE reports PHR for that PUSCH based on the power parameters of the scheduled or configured PUSCH (or, in other cases, based on reference power parameters for that component carrier).

In some aspects, the UE 302 may also generate and transmit to the BS 304 a type 1 PHR for the component carrier (e.g., PCell) of the PUCCH transmission. In some cases, the type 1 PHR may include power headroom determined or computed using reference power parameters (e.g., because no PUSCH transmission is configured or scheduled on the same component carrier as the component carrier of the PUCCH transmission). In some aspects, the UE 302 may generate and send to the BS 304 a type 1 PHR to assist the BS 304 to compensate for the extra PUSCH transmission reference power terms in PH_{type2}(i), as discussed below. The reason for the compensation of the extra PUSCH transmission reference power terms is because no PUCSH transmission was configured or scheduled (and the BS 304 knows about the absence of configuration or scheduling). For example, for the above case where a PUCCH transmission is scheduled or configured on one component carrier c without a PUSCH transmission being scheduled or configured on the same component carrier, the UE 302 may generate and send to the BS 304 a type 1 PHR including a power headroom determined or calculated using the equivalent expression, (equation 3 above), for the LTE case,

PH_{type1,c}(i)=\tilde{P}_{CMAX,c}(i)−{P_{O_PUSCH,c}(j)+α_{c}(j)·PL_{c}+f_{c}(i)}.

At action 330, the UE 302 may transmit the generated type 2′ PHR and/or type 1 PHR to the NR BS 304 including the PUSCH transmission reference power.

At action 340, upon receiving the PHRs, i.e., the type 2′ PHR and/or type 1 PHR, the BS 304 may determine the power headroom available to the UE 302 for simultaneous or parallel transmissions of PUSCH and PUCCH on different component carriers when a PUCCH transmission is scheduled or configured on one component carrier c without a PUSCH transmission being scheduled or configured on the same component carrier. Because the BS 304 knows no PUSCH transmission was scheduled or configured, the BS 304 may know that it has to compensate for or remove otherwise the extra PUSCH transmission reference power terms from PH_{type2}(i). In some cases, the BS 304 may compensate for the extra PUSCH transmission reference power terms in PH_{type2}(i) (Eq. 6) based on PH_{type1,c}(i) (Eq. 3). For example, the BS 304 may determine the PUSCH transmission reference power from PH_{type1,c}(i) and then compensate for (e.g., subtract out) from PH_{type2}(i) this value, which corresponds to the contribution of the PUSCH transmission reference power to PH_{type2}(i), to determine the power headroom available to the UE 302 for simultaneous or parallel transmissions of PUSCH and PUCCH on different component carriers when a PUCCH transmission is scheduled or configured on one component carrier c without a PUSCH transmission being scheduled or configured on the same component carrier.

In some aspects, the type 2′ PHR generated at action 320 may include power headroom for when only PUSCH transmission is scheduled or configured on one component carrier (e.g., PCell/PSCell). That is, no PUCCH transmission may be scheduled or configured on the same component carrier, while only the PUSCH transmission is scheduled or configured on the same component carrier. In such cases, the type 2′ PHR may include a power headroom including an actual power of the PUSCH transmission and a reference power of a PUCCH transmission. In some aspects, the power headroom may be determined or calculated using the expression (Eq. 5) for the equivalent LTE type 2 power headroom for when PUSCH is configured or scheduled but PUCCH is not configured or scheduled, for transmission on the component carrier c, i.e., for when the UE transmits PUSCH without PUCCH in slot i of the primary cell,

$$P {H}_{type 2} ( i ) = {P}_{CMAX , c} ( i ) - 10 {log}_{10} ( \begin{matrix}{10}^{( 10 {log}_{10} ( {M}_{PUSCH , c} ( i ) ) + {P}_{O\_PUSCH , c} ( j ) + {α}_{c} ( j ) \cdot {PL}_{c} + {Δ}_{TF , c} ( i ) + {f}_{c} ( i ) ) / 10} + \\ {10}^{( {P}_{0 \_ PUCCH} + P {L}_{c} + g ( i ) ) / 10}\end{matrix} ) .$$

In some aspects, the UE 302 may also generate and transmit to the BS 304 a type 1 PHR for the component carrier (e.g., PCell) of the PUSCH transmission. In some cases, the type 1 PHR may include power headroom determined or computed using reference power parameters (e.g., because no PUCCH transmission was scheduled or configured on the same component carrier as that of the PUSCH transmission). In some aspects, the UE 302 may generate and send to the BS 304 a type 1 PHR to assist the BS 304 to compensate for the extra PUCCH transmission reference power term in PH_{type2}(i), as discussed below. The reason for the compensation of the extra PUCCH transmission reference power term is because no PUCCH transmission was configured or scheduled (and the BS 304 knows about the absence of configuration or scheduling). For example, for the above case where a PUSCH transmission is scheduled or configured on one component carrier c without a PUCCH transmission being scheduled or configured on the same component carrier, the UE 302 may generate and send to the BS 304 a type 1 PHR including a power headroom determined or calculated using the equivalent expression, (equation 1 above), for the LTE case,

PH_{type1,c}(i)=P_{CMAX,c}(i)−{10 log₁₀(M_{PUSCH,c}(i))+P_{O_PUSCH,c}(j)+α_{c}(j)·PL_{c}+Δ_{TF,c}(i)+f_{c}(i)},

At action 330, the UE 302 may transmit to the NR BS 304 the generated type 2′ PHR including the power headroom for the PUSCH-only transmission and/or the type 1 PHR including the scheduled or configured power for the PUSCH transmission.

At action 340, upon receiving the PHRs, i.e., the type 2′ PHR and/or type 1 PHR, the BS 304 may determine the power headroom available to the UE 302 for simultaneous or parallel transmissions of PUSCH and PUCCH on different component carriers when a PUSCH transmission is scheduled or configured on one component carrier c without a PUCCH transmission being scheduled or configured on the same component carrier. Because the BS 304 knows no PUCCH transmission was scheduled or configured, the BS 304 may know that it has to compensate for or remove otherwise the extra PUCCH transmission reference power terms from PH_{type2}(i) (Eq. 5). In some cases, the BS 304 may compensate for the extra PUCCH transmission reference power term in PH_{type2}(i) (Eq. 5) based on PH_{type1,c}(i) (Eq. 1). For example, the BS 304 may estimate the pathloss from PH_{type1,c}(i) (Eq. 1) and the estimated value to remove the extra PUCCH transmission reference power terms from PH_{type2}(i) (Eq. 5) to determine the power headroom available to the UE 302 for simultaneous or parallel transmissions of PUSCH and PUCCH on different component carriers when a PUSCH transmission is scheduled or configured on one component carrier c without a PUCCH transmission being scheduled or configured on the same component carrier. In some aspects, the PHR for all other component carriers may be based on the configured PHR type, and the related equations. That is, for example, if a PUSCH transmission and a PUCCH transmission are configured or scheduled for transmission on a component carrier, and the configured PHR type can be type 1, then the PHR may include a power headroom computed using equation 2.

Some aspects of the present disclosure disclose a new type of PHR for reporting power headroom at the UE 302 for simultaneous or parallel transmissions to the BS 304 of PUSCH and PUCCH on different component carriers. In some aspects, at action 320, in addition to or instead of generating a type 2′ PHR, the UE 302 may generate, after the triggering of a NR PHR when one or more PHR triggering conditions disclosed above are fulfilled, a new kind of PHR (referred hereinafter as “type 4”). In some aspects, when a PUCCH transmission is scheduled or configured on a component carrier (e.g., PCell/PSCell), type 4 PHR may include a power headroom that includes or is based on the actual power parameters configured for the PUCCH transmission. That is, the power headroom for simultaneous or parallel transmissions to the BS 304 of PUSCH and PUCCH on different component carriers when a PUCCH transmission is scheduled or configured on a component carrier may be based on the actual power parameters configured for the PUCCH transmission. When a PUCCH transmission is not scheduled or configured, in some aspects, reference parameters may be used as discussed above.

For example, in some aspects, if only a PUCCH transmission is scheduled or configured for transmission from UE 302 to BS 304 on a component carrier (i.e., no PUSCH transmission is scheduled or configured for transmission on the same component carrier), a type 4 PHR for a PUCCH transmission from the UE 302 to the BS 304 may include a power headroom determined based on the transmission power of the PUCCH transmission. For instance, the power headroom may include the terms of equation 6 that are related to PUCCH transmissions (e.g., in some cases only related to PUCCH transmissions). In some aspects, if there is no PUCCH transmission scheduled or configured for transmission from UE 302 to BS 304 on a component carrier, then the power headroom may be determined based on a PUCCH reference transmission power. For instance, the power headroom may include the terms of equation 7 that are related to PUCCH transmissions (e.g., in some cases only related to PUCCH transmissions).

In some aspects, if only a PUSCH transmission is scheduled or configured for transmission from UE 302 to BS 304 on a component carrier (i.e., no PUCCH transmission is scheduled or configured for transmission on the same component carrier), a type 4 PHR for a PUSCH transmission from the UE 302 to the BS 304 may include a power headroom determined based on the transmission power of the PUSCH transmission. For instance, the power headroom may include the terms of equation 1 or 5 that are related to PUSCH transmissions (e.g., in some cases only related to PUCCH transmissions). In some aspects, if there is no PUSCH transmission scheduled or configured for transmission from UE 302 to BS 304 on a component carrier, then the power headroom may be determined based on a PUSCH reference transmission power. For instance, the power headroom may include the terms of equation 3 or 7 that are related to PUSCH transmissions (e.g., in some cases only related to PUSCH transmissions).

In some aspects, when a PUSCH transmission is scheduled or configured on a component carrier (e.g., PCell/PSCell), the UE 302 may generate and send to the BS 304 a type 1 PHR that includes a power headroom that is based on the actual power parameters configured for the PUSCH transmission. That is, the power headroom for simultaneous or parallel transmissions to the BS 304 of PUSCH and PUCCH on different component carriers when a PUSCH transmission is scheduled or configured on a component carrier may be based on the actual power parameters configured for the PUSCH transmission. When a PUSCH transmission is not scheduled or configured, in some aspects, reference parameters may be used as discussed above. In some aspects, the PHR for all other component carriers may be based on the configured PHR type, and the related equations. That is, for example, if a PUSCH transmission and a PUCCH transmission are configured or scheduled for transmission on a component carrier, and the configured PHR type can be type 1, then the PHR may include a power headroom computed using equation 2.

In some aspects, the UE 302 may generate and transmit to the BS 304 the new PHR types introduced in the present disclosure, type 2′ PHR and/or type 4, for simultaneous or parallel transmissions to the BS 304 of PUSCH and PUCCH on different component carriers if the UE 302 is configured to support type 2′ PHR and/or type 4 power headroom reporting, respectively. In some aspects, the UE 302 may not be configured to generate and transmit to the BS 304 type 2′ and/or type 4 PHR, in which case the UE 302 may generate and transmit to the BS 304 legacy PHR specified or defined in, for example, in 5G NR 3GPP specification Release 15. That is, if the UE 302 is not configured to support type 2′ or type 4 power headroom reporting for PUCCH and/or PUSCH transmissions that are scheduled or configured on different component carriers, in some aspects, the UE 302 may generate and transmit to the BS 304 type 1 and/or type 3 PHRs as specified in 5G NR 3GPP specification Release 15 for the respective transmission type(s).

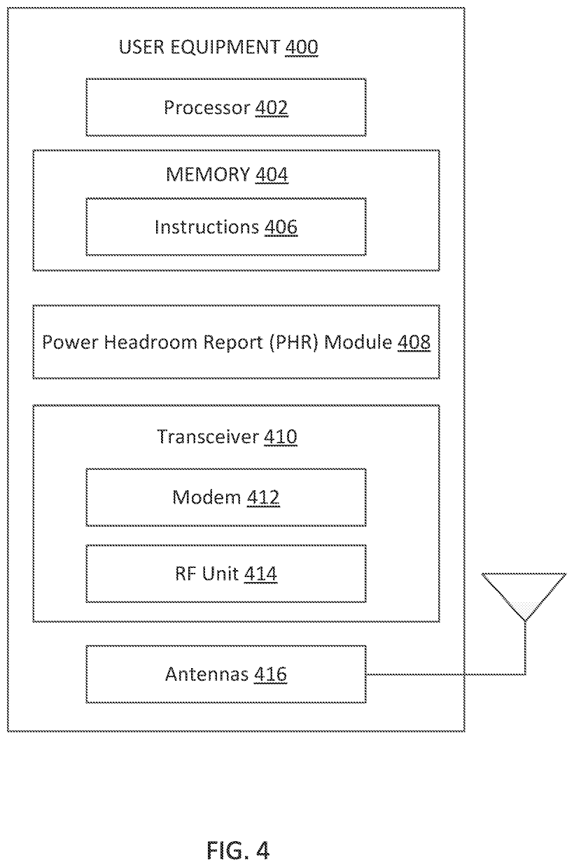

FIG. 4 is a block diagram of an exemplary UE 400 according to some aspects of the present disclosure. The UE 400 may be a UE 115 in the network 100 as discussed above in FIG. 1. As shown, the UE 400 may include a processor 402, a processor 402, a PHR module 408, a transceiver 410 including a modem subsystem 412 and a RF unit 414, and one or more antennas 416. These elements may be in direct or indirect communication with each other, for example via one or more buses.

The processor 402 may have various features as a specific-type processor. For example, these may include a CPU, a DSP, an ASIC, a controller, a FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The processor 402 may include a cache memory (e.g., a cache memory of the processor 402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the processor 402 may include a non-transitory computer-readable medium. The processor 402 may store instructions 406. The instructions 406 may include instructions that, when executed by the processor 402, cause the processor 402 to perform operations described herein, for example, aspects of FIGS. 1-3 and 6. Instructions 406 may also be referred to as program code. The program code may be for causing a wireless communication device to perform these operations, for example by causing one or more processors (such as processor 402) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The PHR module 408 may be implemented via hardware, software, or combinations thereof. For example, the PHR module 408 may be implemented as a processor, circuit, and/or instructions 406 stored in the processor 402 and executed by the processor 402. In some examples, the PHR module 408 can be integrated within the modem subsystem 412. For example, the PHR module 408 can be implemented by a combination of software components (e.g., executed by a DSP or a general processor) and hardware components (e.g., logic gates and circuitry) within the modem subsystem 412.

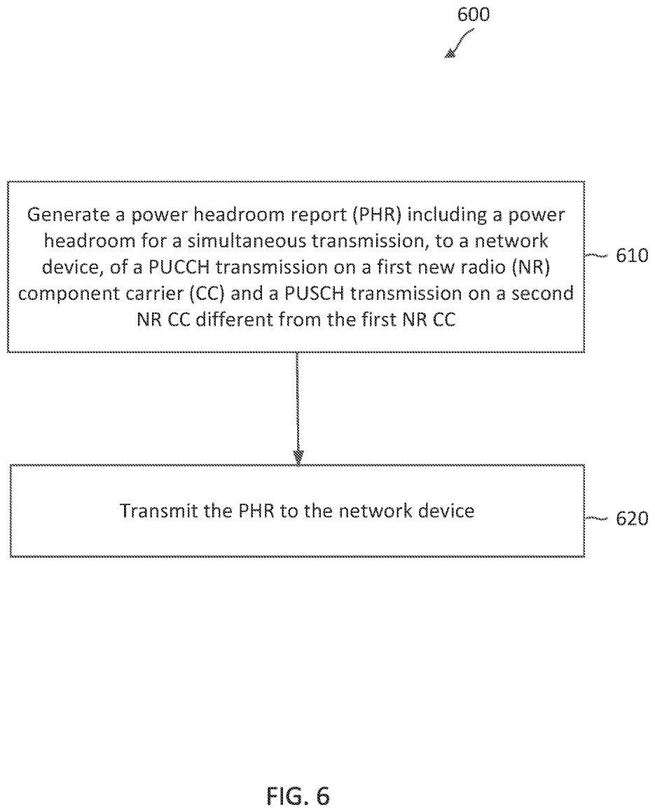

The PHR module 408 may be used for various aspects of the present disclosure, for example, aspects of FIGS. 3 and 6. For example, the PHR module 408 may be configured to generate a power headroom report including a power headroom for simultaneous transmission, to a BS (e.g., 500), of a PUCCH transmission on a first NR CC and a PUSCH transmission on a second NR CC different from the first NR CC. The PHR module 408 may also be configured to transmit, to the BS, the PHR including the power headroom.

As shown, the transceiver 410 may include the modem subsystem 412 and the RF unit 414. The transceiver 410 can be configured to communicate bi-directionally with other devices, such as the UEs 114 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data (e.g., PDSCH signal, PDCCH signal, SRS resource configuration, SRS resource activation, SRS resource deactivation) from the modem subsystem 412 (on outbound transmissions) or of transmissions originating from another source such as a UE 115. The RF unit 414 may be further configured to perform analog beamforming in conjunction with the digital beamforming. Although shown as integrated together in transceiver 410, the modem subsystem 412 and/or the RF unit 414 may be separate devices that are coupled together at the UE 400 to enable the UE 400 to communicate with other devices.

The RF unit 414 may provide modulated and/or processed data, e.g. data packets (or, more generally, data messages that may contain one or more data packets and other information), to the antennas 416 for transmission to one or more other devices. This may include, for example, transmission of information to complete attachment to a network and communication with a camped UE 115 according to some aspects of the present disclosure. The antennas 416 may further receive data messages transmitted from other devices and provide the received data messages for processing and/or demodulation at the transceiver 410. The transceiver 410 may provide the demodulated and decoded data (e.g., PUSCH signal, UL data, SRSs, UE capability reports, RI reports) to the SRS module 408 for processing. The antennas 416 may include multiple antennas of similar or different designs to sustain multiple transmission links.

In an aspect, the UE 400 can include multiple transceivers 410 implementing different RATs (e.g., NR and LTE). In an aspect, the UE 400 can include a single transceiver 410 implementing multiple RATs (e.g., NR and LTE). In an aspect, the transceiver 410 can include various components, where different combinations of components can implement different RATs.

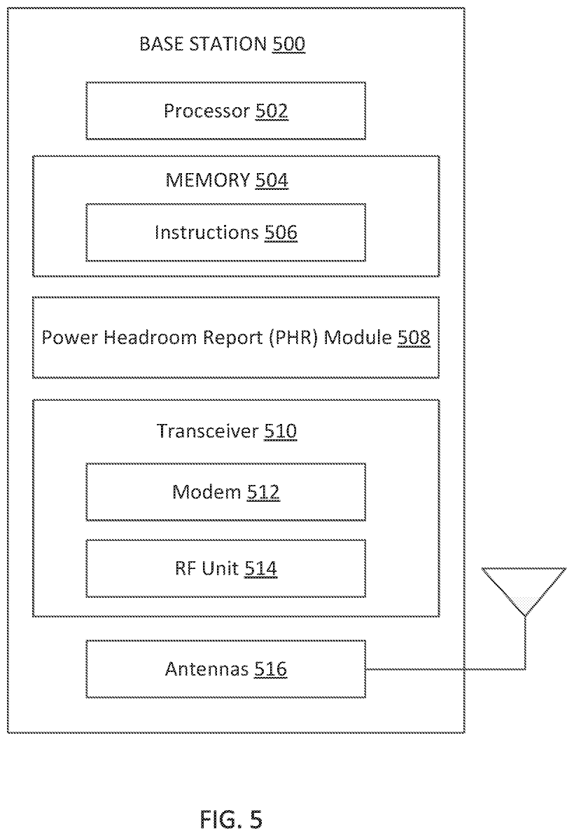

FIG. 5 is a block diagram of an exemplary NR BS 500 according to some aspects of the present disclosure. The BS 500 may be a BS 105 discussed above in FIG. 1. As shown, the BS 500 may include a processor 502, a memory 504, a PHR module 508, a transceiver 510 including a modem subsystem 512 and a radio frequency (RF) unit 514, and one or more antennas 516. These elements may be in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 504 includes a non-transitory computer-readable medium. The memory 504 may store, or have recorded thereon, instructions 506. The instructions 506 may include instructions that, when executed by the processor 502, cause the processor 502 to perform the operations described herein with reference to the BSs 105 in connection with aspects of the present disclosure, for example, aspects of FIGS. 1-3, 7 and 8. Instructions 506 may also be referred to as program code, which may be interpreted broadly to include any type of computer-readable statement(s) as discussed above with respect to FIG. 5.

The PHR module 508 may be implemented via hardware, software, or combinations thereof. For example the PHR module 508 may be implemented as a processor, circuit, and/or instructions 506 stored in the memory 504 and executed by the processor 502. In some examples, the PHR module 508 can be integrated within the modem subsystem 512. For example, the PHR module 508 can be implemented by a combination of software components (e.g., executed by a DSP or a general processor) and hardware components (e.g., logic gates and circuitry) within the modem subsystem 512.

The PHR module 508 may be used for various aspects of the present disclosure, for example, aspects of FIGS. 1-3, 7 and 8. The PHR module 508 may be configured to receive, from a UE (e.g., 105 or 400), a first PHR including a first power headroom and a second PHR including a second power headroom, where the first power headroom including a transmission power of a PUCCH transmission on a first NR CC and a transmission power of a reference PUSCH transmission on a first NR CC and the second power headroom including a transmission power of the reference PUSCH transmission on the first NR CC with no PUSCH transmission configured for transmission on the first NR CC. The PHR module 508 may further determine, based on the first power headroom and the second power headroom, a third power headroom for simultaneous transmission, by the UE to the BS, of the PUCCH transmission on the first NR CC and a PUSCH transmission on a second NR CC different from the first NR CC.

In some aspects, the PHR module 508 may be configured to receive, from a UE, a first PHR including a first power headroom and a second PHR including a second power headroom, where the first power headroom including a transmission power of a reference PUCCH transmission on a first NR CC and a transmission power of a PUSCH transmission transmitted to the BS on the first NR CC and the second power headroom including the transmission power of the PUSCH transmission on the first NR CC with no PUCCH transmission configured for transmission on the first NR CC. The PHR module 508 may further determine, based on the first power headroom and the second power headroom, a third power headroom for simultaneous transmission, by the UE to the BS, of the PUSCH transmission on the first NR CC and a PUCCH transmission on a second NR CC different from the first NR CC.

As shown, the transceiver 510 may include a modem subsystem 512 and an RF unit 514. The transceiver 510 can be configured to communicate bi-directionally with other devices, such as the BSs 105. The modem subsystem 512 may be configured to modulate and/or encode the data from the memory 504 according to a modulation and coding scheme (MCS), e.g., a low-density parity check (LDPC) coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data (e.g., PUSCH signal, UL data, SRSs, UE capability reports, RI reports) from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together at the BS 500 to enable the BS 500 to communicate with other devices.

The RF unit 514 may provide modulated and/or processed data, e.g. data packets (or, more generally, data messages that may contain one or more data packets and other information), to the antennas 516 for transmission to one or more other devices. The antennas 516 may further receive data messages transmitted from other devices. The antennas 516 may provide the received data messages for processing and/or demodulation at the transceiver 510. The transceiver 510 may provide the demodulated and decoded data (e.g., PDSCH signal, PDCCH, DL data, SRS resource configuration, SRS resource activation, SRS resource deactivation) to the PHR module 508. The antennas 516 may include multiple antennas of similar or different designs in order to sustain multiple transmission links. The RF unit 514 may configure the antennas 516.

In an aspect, the BS 500 can include multiple transceivers 510 implementing different RATs (e.g., NR and LTE). In an aspect, the BS 500 can include a single transceiver 510 implementing multiple RATs (e.g., NR and LTE). In an aspect, the transceiver 510 can include various components, where different combinations of components can implement different RATs.

FIG. 6 is a flow diagram of a wireless communication method 600, according to some aspects of the present disclosure. Aspects of the method 600 can be executed by a computing device (e.g., a processor, processing circuit, and/or other suitable component) of a wireless communication device or other suitable means for performing the steps. For example, a wireless communication device, such as the UEs 115 and/or 400 may utilize one or more components, such as the processor 402, the processor 402, the PHR module 408, the transceiver 410, the modem 412, and the one or more antennas 416, to execute the steps of method 600. As illustrated, the method 600 includes a number of enumerated steps, but aspects of the method 600 may include additional steps before, after, and in between the enumerated steps. In some aspects, one or more of the enumerated steps may be omitted or performed in a different order.

At block 610, a UE (e.g., the UEs 115 and/or 400) can determine a power headroom for simultaneous transmission, to a base station (BS), of a PUCCH transmission on a first new radio (NR) component carrier (CC) and a PUSCH transmission on a second NR CC different from the first NR CC.

At block 620, the UE may transmit, to the BS, a power headroom report (PHR) including the power headroom.

In some aspects, no PUCCH transmission is configured for transmission to the network device on the second NR CC and the PUSCH transmission is configured for transmission to the network device on the second NR CC. In some instances, method 600 may further comprise computing the power headroom based at least in part on a transmission power of the PUSCH transmission on the second NR CC and a transmission power of a reference PUCCH transmission on the second NR CC, assuming a combined PUSCH and PUCCH transmission on the second NR CC. In some instances, method 600 may further comprise computing the power headroom based at least in part on a transmission power of the PUSCH transmission on the second NR CC, assuming a PUSCH only transmission on the second NR CC.

In some aspects, the PUCCH transmission is configured for transmission to the network device on the first NR CC and no PUSCH transmission is configured for transmission to the network device on the first NR CC. In some instances, method 600 may comprise computing the power headroom based at least in part on a transmission power of the PUCCH transmission on the first NR CC and a transmission power of a reference PUSCH transmission on the first NR CC, assuming a combined PUSCH and PUCCH transmission on the first NR CC. In some instances, method 600 may further comprise computing the power headroom based at least in part on a transmission power of a reference PUSCH transmission on the first NR CC, assuming a PUSCH only transmission on the first NR CC.

In some aspects, the PUCCH transmission is configured for transmission to the network device on the first NR CC, and method 600 may further comprise: computing the power headroom based at least in part on a transmission power the PUCCH transmission on the first NR CC.

In some aspects, the PUSCH transmission is configured or scheduled for transmission to the network device on the second NR CC, and method 600 may further comprise: computing the PUSCH transmission is configured or scheduled for transmission to the network device on the second NR CC.

In some aspects, no PUCCH transmission is configured for transmission to the BS on the second NR CC and the PUSCH transmission is configured for transmission to the BS on the second NR CC. Further, the PUCCH transmission is configured for transmission to the BS on the first NR CC and no PUSCH transmission is configured for transmission to the BS on the first NR CC. In some aspects, the power headroom is determined based at least in part on a transmission power of the PUCCH transmission on the first NR CC and a transmission power of a reference PUSCH transmission on the first NR CC. In some aspects, the power headroom is determined based at least in part on a transmission power of the PUSCH transmission on the second NR CC with no PUCCH transmission configured for transmission on the second NR CC.

In some aspects, the power headroom is determined based at least in part on a transmission power of a reference PUCCH transmission on the second NR CC and a transmission power of the PUSCH transmission on the second NR CC. In some aspects, the power headroom is determined based at least in part on a transmission power of a reference PUSCH transmission on the first NR CC. In some aspects, the power headroom determined based at least in part on a transmission power of the PUSCH transmission on the second NR CC.

In some aspects, the PUCCH transmission is configured for transmission to the BS on the first NR CC, the power headroom determined based at least in part on a transmission power of the PUCCH transmission on the first NR CC. In some cases, no PUSCH transmission is configured for transmission on the first NR CC.

In some aspects, the PUSCH transmission is configured for transmission to the BS on the second NR CC, the power headroom determined based at least in part on a transmission power of the PUSCH transmission on the second NR CC. In some aspects, no PUCCH transmission is configured for transmission on the second NR CC.

In some aspects, the PHR is a multi-entry medium access control (MAC)-control element (CE) message.

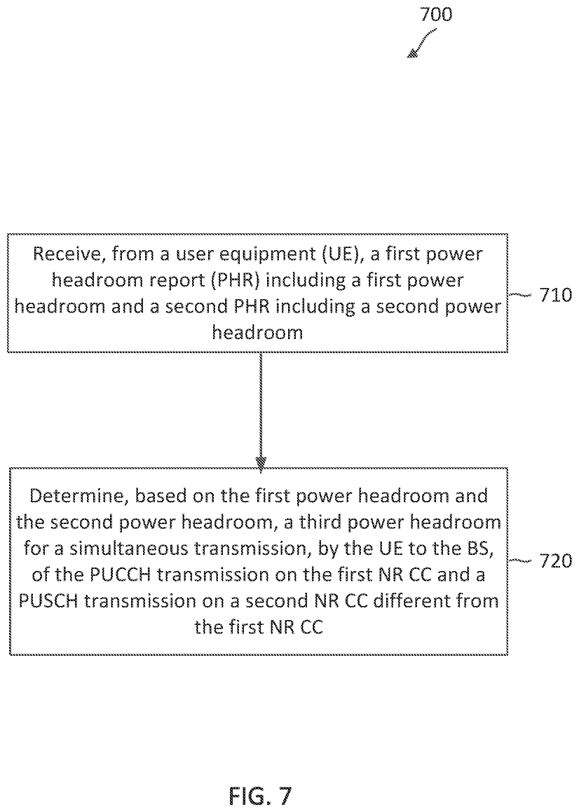

FIG. 7 is a flow diagram of a wireless communication method 700, according to some aspects of the present disclosure. Aspects of the method 700 can be executed by a computing device (e.g., a processor, processing circuit, and/or other suitable component) of a wireless communication device or other suitable means for performing the steps. For example, a wireless communication device, such as the BSs 105 and/or 500 may utilize one or more components, such as the processor 502, the processor 502, the PHR module 508, the transceiver 510, the modem 512, and the one or more antennas 516, to execute the steps of method 700. As illustrated, the method 700 includes a number of enumerated steps, but aspects of the method 700 may include additional steps before, after, and in between the enumerated steps. In some aspects, one or more of the enumerated steps may be omitted or performed in a different order.

At block 710, a BS (e.g., the UEs 105 and/or 500) can receive, from a user equipment (UE), a first power headroom report (PHR) including a first power headroom and a second PHR including a second power headroom. In some aspects, the first power headroom may include a transmission power of a PUCCH transmission on a first NR CC and a transmission power of a reference PUSCH transmission on a first NR CC. In some aspects, the second power headroom may include a transmission power of the reference PUSCH transmission on the first NR CC with no PUSCH transmission configured for transmission on the first NR CC.

At block 720, the BS may determine, based on the first power headroom and the second power headroom, a third power headroom for simultaneous transmission, by the UE to the BS, of the PUCCH transmission on the first NR CC and a PUSCH transmission on a second NR CC different from the first NR CC.

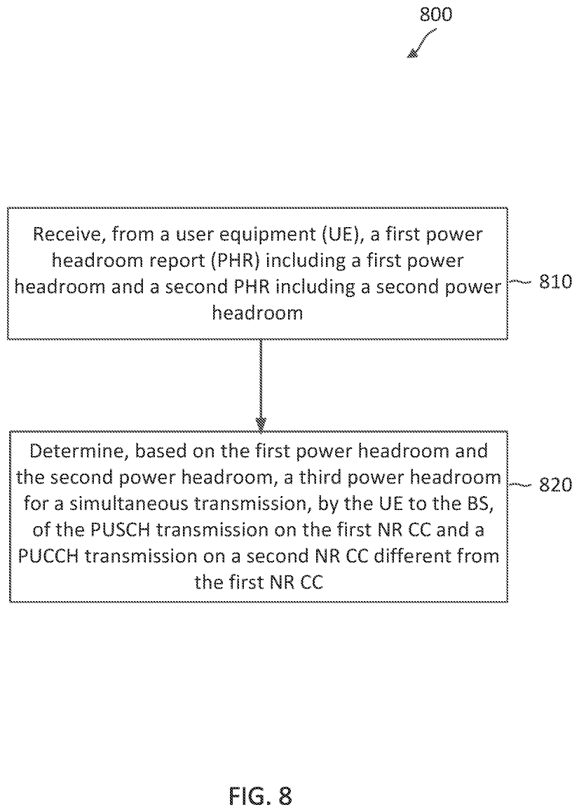

FIG. 8 is a flow diagram of a wireless communication method 800, according to some aspects of the present disclosure. Aspects of the method 800 can be executed by a computing device (e.g., a processor, processing circuit, and/or other suitable component) of a wireless communication device or other suitable means for performing the steps. For example, a wireless communication device, such as the BSs 105 and/or 500 may utilize one or more components, such as the processor 502, the processor 502, the PHR module 508, the transceiver 510, the modem 512, and the one or more antennas 516, to execute the steps of method 800. As illustrated, the method 800 includes a number of enumerated steps, but aspects of the method 800 may include additional steps before, after, and in between the enumerated steps. In some aspects, one or more of the enumerated steps may be omitted or performed in a different order.

At block 810, a BS (e.g., the UEs 105 and/or 500) can receive, from a user equipment (UE), a first power headroom report (PHR) including a first power headroom and a second PHR including a second power headroom. In some aspects, the first power headroom may include a transmission power of a reference PUCCH transmission on a first NR CC and a transmission power of a PUSCH transmission transmitted to the BS on the first NR CC. In some aspects, the second power headroom may include the transmission power of the PUSCH transmission on the first NR CC with no PUCCH transmission configured for transmission on the first NR CC.

At block 820, the BS may determine, based on the first power headroom and the second power headroom, a third power headroom for simultaneous transmission, by the UE to the BS, of the PUSCH transmission on the first NR CC and a PUCCH transmission on a second NR CC different from the first NR CC.

### RECITATIONS OF SOME ASPECTS OF THE PRESENT DISCLOSURE

Aspect 1: A method of wireless communication performed by a user equipment (UE), the method comprising: generating a power headroom report (PHR) including a power headroom for a simultaneous transmission, to a network device, of a PUCCH transmission on a first new radio (NR) component carrier (CC) and a PUSCH transmission on a second NR CC different from the first NR CC; and transmitting the PHR to the network device.

Aspect 2: The method of aspect 1, wherein no PUCCH transmission is configured for transmission to the network device on the second NR CC and the PUSCH transmission is configured for transmission to the network device on the second NR CC.

Aspect 3: The method of aspect 1 or 2, further comprising: computing the power headroom based at least in part on a transmission power of the PUSCH transmission on the second NR CC and a transmission power of a reference PUCCH transmission on the second NR CC, assuming a combined PUSCH and PUCCH transmission on the second NR CC.

Aspect 4: The method of aspect 1 or 2, further comprising: computing the power headroom based at least in part on a transmission power of the PUSCH transmission on the second NR CC, assuming a PUSCH only transmission on the second NR CC.

Aspect 5: The method of aspect 1, wherein the PUCCH transmission is configured for transmission to the network device on the first NR CC and no PUSCH transmission is configured for transmission to the network device on the first NR CC.

Aspect 6: The method of aspect 1 or 5, further comprising: computing the power headroom based at least in part on a transmission power of the PUCCH transmission on the first NR CC and a transmission power of a reference PUSCH transmission on the first NR CC, assuming a combined PUSCH and PUCCH transmission on the first NR CC.

Aspect 7: The method of aspect 1 or 5, further comprising: computing the power headroom based at least in part on a transmission power of a reference PUSCH transmission on the first NR CC, assuming a PUSCH only transmission on the first NR CC.

Aspect 8: The method of aspect 1, wherein the PUCCH transmission is configured for transmission to the network device on the first NR CC, the method further comprising: computing the power headroom based at least in part on a transmission power the PUCCH transmission on the first NR CC.

Aspect 9: The method of aspect 1, wherein the PUSCH transmission is configured or scheduled for transmission to the network device on the second NR CC, the method further comprising: computing the PUSCH transmission is configured or scheduled for transmission to the network device on the second NR CC.

Aspect 10: The method of aspect 1-9, wherein the PHR is a multi-entry medium access control (MAC)-control element (CE) message.

Aspect 11: A user equipment (UE), comprising: a memory; a processor coupled to the memory; and a transceiver coupled to the processor, the UE configured to perform the methods of aspects 1-10.

Aspect 12: A non-transitory computer-readable medium (CRM) having program code recorded thereon, the program code comprises code for causing a user equipment (UE) to perform the methods of aspects 1-10.

Aspect 13: A user equipment (UE) comprising means for performing the methods of aspects 1-10.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a user equipment (UE), the method comprising:
generating a power headroom report (PHR) including a power headroom for a simultaneous transmission, to a network device, of a PUCCH transmission on a first new radio (NR) component carrier (CC) and a PUSCH transmission on a second NR CC different from the first NR CC; and
transmitting the PHR to the network device.

2. The method of claim 1, wherein no PUCCH transmission is configured or scheduled for transmission to the network device on the second NR CC and the PUSCH transmission is configured or scheduled for transmission to the network device on the second NR CC.

3. The method of claim 2, further comprising: computing the power headroom based at least in part on a transmission power of the PUSCH transmission on the second NR CC and a transmission power of a reference PUCCH transmission on the second NR CC, assuming a combined PUSCH and PUCCH transmission on the second NR CC.

4. The method of claim 2, further comprising: computing the power headroom based at least in part on a transmission power of the PUSCH transmission on the second NR CC, assuming a PUSCH only transmission on the second NR CC.

5. The method of claim 1, wherein the PUCCH transmission is configured or scheduled for transmission to the network device on the first NR CC and no PUSCH transmission is configured or scheduled for transmission to the network device on the first NR CC.

6. The method of claim 5, further comprising: computing the power headroom based at least in part on a transmission power of the PUCCH transmission on the first NR CC and a transmission power of a reference PUSCH transmission on the first NR CC, assuming a combined PUSCH and PUCCH transmission on the first NR CC.

7. The method of claim 5, further comprising: computing the power headroom based at least in part on a transmission power of a reference PUSCH transmission on the first NR CC, assuming a PUSCH only transmission on the first NR CC.

8. The method of claim 1, wherein the PUCCH transmission is configured or scheduled for transmission to the network device on the first NR CC, the method further comprising:
computing the power headroom based at least in part on a transmission power the PUCCH transmission on the first NR CC.

9. The method of claim 1, wherein the PUSCH transmission is configured or scheduled for transmission to the network device on the second NR CC, the method further comprising:
computing the power headroom based at least in part on a transmission power of the PUSCH transmission on the second NR CC, assuming a PUSCH only transmission on the second NR CC.

10. The method of claim 1, wherein the PHR is a multi-entry medium access control (MAC)-control element (CE) message.

11. A user equipment (UE), comprising:
a memory;
a processor coupled to the memory and configured to:
generate a power headroom report (PHR) including a power headroom for a simultaneous transmission, to a network device, of a PUCCH transmission on a first new radio (NR) component carrier (CC) and a PUSCH transmission on a second NR CC different from the first NR CC; and
a transceiver coupled to the processor and configured to:
transmit the PHR to the network device.

12. The UE of claim 11, wherein no PUCCH transmission is configured or scheduled for transmission to the network device on the second NR CC and the PUSCH transmission is configured or scheduled for transmission to the network device on the second NR CC.

13. The UE of claim 12, wherein the processor is further configured to compute the power headroom based at least in part on a transmission power of the PUSCH transmission on the second NR CC and a transmission power of a reference PUCCH transmission on the second NR CC, assuming a combined PUSCH and PUCCH transmission on the second NR CC.

14. The UE of claim 12, wherein the processor is further configured to compute the power headroom based at least in part on a transmission power of the PUSCH transmission on the second NR CC, assuming a PUSCH only transmission on the second NR CC.

15. The UE of claim 11, wherein the PUCCH transmission is configured or scheduled for transmission to the network device on the first NR CC and no PUSCH transmission is configured or scheduled for transmission to the network device on the first NR CC.

16. The UE of claim 15, wherein the processor is further configured to compute the power headroom based at least in part on a transmission power of the PUCCH transmission on the first NR CC and a transmission power of a reference PUSCH transmission on the first NR CC, assuming a combined PUSCH and PUCCH transmission on the first NR CC.

17. The UE of claim 15, wherein the processor is further configured to compute the power headroom based at least in part on a transmission power of a reference PUSCH transmission on the first NR CC, assuming a PUSCH only transmission on the first NR CC.

18. The UE of claim 11, wherein the PUCCH transmission is configured for transmission to the network device on the first NR CC, the processor further configured to:
compute the power headroom based at least in part on a transmission power the PUCCH transmission on the first NR CC.

19. The UE of claim 11, wherein the PUSCH transmission is configured or scheduled for transmission to the network device on the second NR CC, the processor further configured to:
compute the power headroom based at least in part on a transmission power of the PUSCH transmission on the second NR CC, assuming a PUSCH only transmission on the second NR CC.

20. The UE of claim 11, wherein the PHR is a multi-entry medium access control (MAC)-control element (CE) message.

21. A non-transitory computer-readable medium (CRM) having program code recorded thereon, the program code comprising:
code for causing a UE generate a power headroom report (PHR) including a power headroom for a simultaneous transmission, to a network device, of a PUCCH transmission on a first new radio (NR) component carrier (CC) and a PUSCH transmission on a second NR CC different from the first NR CC;
code for causing the UE to transmit the PHR to the network device.

22. The non-transitory CRM of claim 21, wherein no PUCCH transmission is configured or scheduled for transmission to the network device on the second NR CC and the PUSCH transmission is configured or scheduled for transmission to the network device on the second NR CC.

23. The non-transitory CRM of claim 21, wherein the PUCCH transmission is configured or scheduled for transmission to the network device on the first NR CC and no PUSCH transmission is configured or scheduled for transmission to the network device on the first NR CC.

24. The non-transitory CRM of claim 21, wherein the PUCCH transmission is configured or scheduled for transmission to the network device on the first NR CC, the program code further comprising code for causing the UE to:
compute the power headroom based at least in part on a transmission power the PUCCH transmission on the first NR CC.

25. The non-transitory CRM of claim 21, wherein the PUSCH transmission is configured or scheduled for transmission to the network device on the second NR CC, the program code further comprising code for causing the UE to:
compute the power headroom based at least in part on a transmission power of the PUSCH transmission on the second NR CC, assuming a PUSCH only transmission on the second NR CC.

26. A user equipment (UE), comprising:
means for generating a power headroom report (PHR) including a power headroom for a simultaneous transmission, to a network device, of a PUCCH transmission on a first new radio (NR) component carrier (CC) and a PUSCH transmission on a second NR CC different from the first NR CC; and
means for transmitting the PHR to the network device.

27. The UE of claim 26, wherein no PUCCH transmission is configured or scheduled for transmission to the network device on the second NR CC and the PUSCH transmission is configured or scheduled for transmission to the network device on the second NR CC.

28. The UE of claim 26, wherein the PUCCH transmission is configured or scheduled for transmission to the network device on the first NR CC and no PUSCH transmission is configured or scheduled for transmission to the network device on the first NR CC.

29. The UE of claim 26, wherein the PUCCH transmission is configured or scheduled for transmission to the network device on the first NR CC, the UE further comprising means for:
computing the power headroom based at least in part on a transmission power the PUCCH transmission on the first NR CC.

30. The UE of claim 26, wherein the PUSCH transmission is configured or scheduled for transmission to the network device on the second NR CC, the UE further comprising means for:
computing the power headroom based at least in part on a transmission power of the PUSCH transmission on the second NR CC, assuming a PUSCH only transmission on the second NR CC.
